(19) United States
(12) Patent Application Publication
(10) Pub. No.: US 2025/0199931 A1
(43) Pub. Date: Jun. 19, 2025

(54) DEVICE, METHOD AND SYSTEM FOR DETERMINING A FREQUENCY RATIO OF A PROCESSOR WITH INFERENCE ENGINE CIRCUITRY

(71) Applicant: Intel Corporation, Santa Clara, CA (US)

(72) Inventors: Ujjwal Gupta, Chandler, AZ (US); Sai Mahathi Naladala, Hillsboro, OR (US); Ankush Varma, Portland, OR (US)

(73) Assignee: Intel Corporation, Santa Clara, CA (US)

(21) Appl. No.: 18/759,354

(22) Filed: Jun. 28, 2024

Related U.S. Application Data
(60) Provisional application No. 63/611,036, filed on Dec. 15, 2023.

(51) Int. Cl. G06F 11/34; G06F 1/08; G06F 1/3206

(52) U.S. Cl. CPC G06F 11/3409; G06F 1/08; G06F 1/3206

(57) ABSTRACT

Techniques and mechanisms for determining an operational state of a processor with inference engine circuitry. In an embodiment, inference engine circuitry implements a classification function with which a given workload is classified as belonging to any of multiple possible workload classes. Each of the workload classes corresponds to a different respective value of an uncore-core frequency ratio. The inference engine circuitry receives or otherwise identifies telemetry information which is generated during a particular phase of the workload execution. Based on the telemetry information, the inference engine circuitry generates an output specifying or otherwise indicating a recommended frequency ratio value which corresponds to an identified workload class. In another embodiment, a frequency of a core, or a frequency of uncore resource, is changed based on the recommended frequency ratio value.

### CLAIM OF PRIORITY

The present application claims priority under 35 U.S.C. § 119(e) to U.S. Provisional Patent Application Ser. No. 63/611,036 filed Dec. 15, 2023 and entitled “APPARATUS TO DETERMINE FABRIC AND CORE FREQUENCY RATIO CATEGORIZATION FOR OPTIMIZING POWER AND PERFORMANCE IN A MULTI-PROCESSOR SOC,” which is herein incorporated by reference in its entirety.

### BACKGROUND

### 1. Technical Field

This disclosure generally relates to integrated circuitry and more particularly, but not exclusively, to determining an operational state which facilitate efficient power consumption of a circuit.

### 2. Background Art

A multi-processor system-on-chip (MpSoC) is one example of a circuit device which often needs runtime dynamic power and performance management—e.g., to respond to changes in the respective characteristics of one or more workloads during runtime execution thereof. Some existing processor designs have independent controls for the respective frequencies of a processor core and a fabric, which (for example) may have a shared power budget. Usually, allocation of one or more core frequencies and an uncore frequency varies over time based on changes to workload characteristics. For example, a workload which exhibits relatively often accesses to a memory typically needs a relatively high frequency of an interconnect fabric for the sake of power and performance characteristics. By contrast, a workload which exhibits relatively rare memory accesses typically needs a relatively high frequency of a processor core. This is becoming even more important for optimal power allocation between core and fabric in emerging technology areas, such as, high bandwidth memory products and large core count products that have very large network-on-chips (>50 fabric agents).

### BRIEF DESCRIPTION OF THE DRAWINGS

The various embodiments of the present invention are illustrated by way of example, and not by way of limitation, in the figures of the accompanying drawings and in which:

FIG. 1 shows a block diagram illustrating features of a system to facilitate the provisioning of a classification function to an inference engine according to an embodiment.

FIG. 2 shows a flow diagram illustrating features of a method to generate a classification function with a machine learning model according to an embodiment.

FIG. 3 shows a flow diagram illustrating features of a method to classify a workload with an inference engine circuit according to an embodiment.

FIG. 4 shows a block diagram illustrating features of a system to enable workload classification with an inference engine according to an embodiment.

FIG. 5 shows a block diagram illustrating features of a processor to dynamically adapt an power allocation to various domains according to an embodiment.

FIG. 6 shows a flow diagram illustrating features of a method to determine dynamic modifications to an allocation of a power budget according to an embodiment.

FIG. 7 illustrates an exemplary system.

FIG. 8 illustrates a block diagram of an example processor that may have more than one core and an integrated memory controller.

FIG. 9A is a block diagram illustrating both an exemplary in-order pipeline and an exemplary register renaming, out-of-order issue/execution pipeline according to examples.

FIG. 9B is a block diagram illustrating both an exemplary example of an in-order architecture core and an exemplary register renaming, out-of-order issue/execution architecture core to be included in a processor according to examples.

### DETAILED DESCRIPTION

Embodiments discussed herein variously provide techniques and mechanisms for determining an operational state of a processor with inference engine circuitry. The description herein includes numerous details to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

In traditional power management techniques, finding an efficient allocation of an uncore frequency (e.g., including a fabric frequency) and a core frequency at runtime is not straightforward. Current techniques, employed in various processor designs, implement an uncore frequency scaling (UFS) algorithm that utilizes heuristics—e.g., based on fabric traffic, and a fixed linear UFS running average power limit (RAPL) relation—for determining a frequency budget between core resources and uncore resources. However, these heuristics usually require tuning for any one individual product. Moreover, with the rapidly diversifying types of workloads, simpler approaches—such as those based on heuristics—force processors (and processor designers) to make sub-optimal power and performance tradeoffs. Furthermore, adding new counters to such heuristics is challenging where it is associated with a large change in circuit design. As a result, current solutions would benefit from a rigorous and uniform mechanism that is able to work across different products and/or deployment scenarios.

In various embodiments, classifier functionality is provided with inference engine logic—e.g., comprising a machine learning model, such as cubic support vector machine (SVM) classification model, for example—which is trained based on an analysis of a variety of workloads. In various embodiments, such inference engine logic (e.g., provided with any of various suitable hardware, firmware and/or executing software) predicts, estimates or otherwise detects a class of a workload phase. For example, a particular workload class indicates or otherwise corresponds to a respective degree and/or type of a boundedness (if any) of a given workload towards a given one or more circuit resources—such as core-bound, fabric-bound, or somewhere in between. In one such embodiment, a given workload is identified by inference engine logic as belonging to a particular one of multiple (e.g., three or more) possible workload classes. Such identification is performed using telemetry that, for example, comprises hardware performance counter information.

In various embodiments, inference engine logic comprises a machine learning model which is trained for a specific optimization objective, such as performance per watt (PPW)—e.g., wherein a particular value of a frequency ratio (such as a uncore/core frequency ratio) is pre-assigned to a particular workload class. At runtime, in each of multiple control intervals (or “workload phases” herein), an inference engine implements a classification function for performing a respective evaluation, based on corresponding telemetry information, to identify a workload as belonging to a particular bounded class (or unbounded class, for example). Based on the detected class, the inference model generates an output which specifies or otherwise indicates a corresponding frequency ratio value, which (for example) is provided as a basis for determining whether (and if so, how) an allocation of a power budget is to be modified.

One example advantage of an inference engine-based classifier mechanism according to various embodiments is an ability to vary an uncore/core frequency ratio (such as a fabric-to-core frequency ratio) at runtime for different workload phases, as opposed to keeping said frequency ratio fixed. Alternatively or in addition, some embodiments provide a flexibility which enables any of various optimization functions to be maximized or otherwise improved—e.g., resulting in improved performance per Watt, improved performance within a power budget and/or the like. Alternatively or in addition, a classifier implementation according to various embodiments is not limited to a particular machine learning technique (such as cubic-SVM), which facilitates any of various mathematical techniques to be employed to build the classifier from various fields of control theory, reinforcement learning, statistical learning, and/or the like.

Accordingly, some embodiments variously enable power management with any of multiple available uncore/core frequency ratio values (e.g., including three or more uncore/core frequency ratio values) each for a different respective one of multiple workload classes. In various embodiments, a given workload is classified as belonging to a particular one of the multiple workload classes based on each of multiple (e.g., three or more) telemetry parameters. In one such embodiment, the multiple telemetry parameters indicate a level and/or type of utilization of a core resource of a processor, a level and/or type of utilization of an uncore resource (such as an interconnect fabric) of the processor, and a level and/or type of utilization of a memory which is coupled to the processor. By contrast, current mechanisms do not enable power management with as many uncore/core frequency ratio values, and/or do not enable workload classification based on as many telemetry parameters.

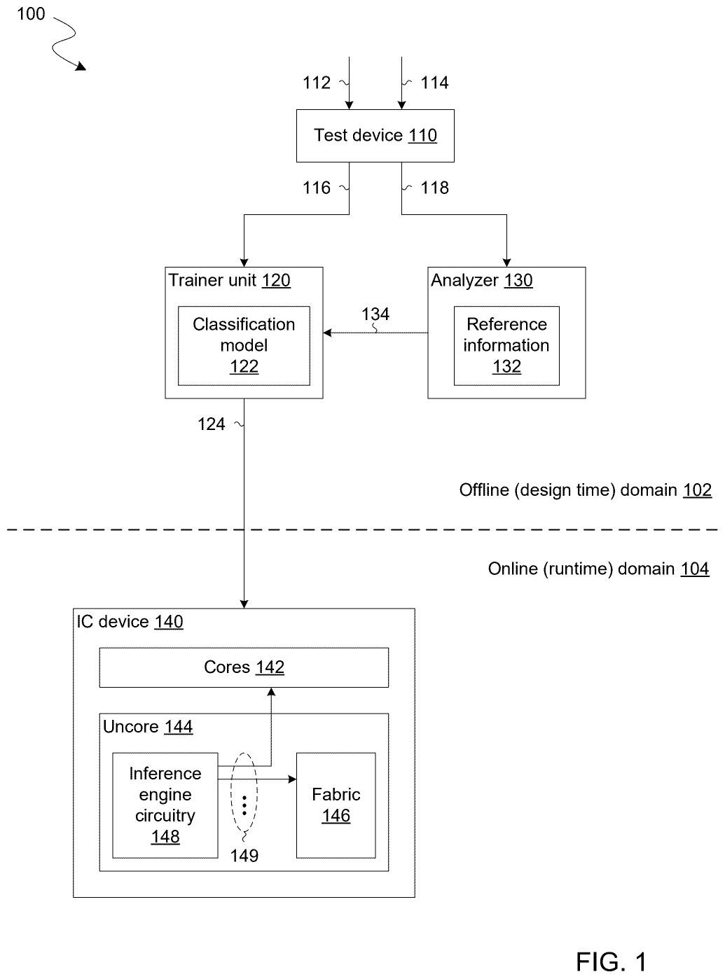

FIG. 1 shows a system 100 which facilitates the provisioning of a classification function to inference engine circuitry according to an embodiment. System 100 illustrates one example of an embodiment which comprises any of various combinations of hardware resources, firmware resources and/or software resources which are suitable to determine a classifier function ƒ(⋅) that, at a runtime, is to evaluate telemetry for an executing workload. In an embodiment, such evaluation facilitates the identification of a recommended value for an uncore/core frequency ratio (β) of a processor. The particular type, number and/or arrangement of such resources vary in different embodiments—e.g., based on a type of categorization to be performed, and number variety and/or complexity of features to provide, and/or the like.

In the example embodiment shown, an offline domain 102 of system 100 comprises resources to train a machine learning model, where said training determines a classification function—e.g., during a post-silicon phase of a design/test project or (alternatively) in a simulation environment during a pre-silicon phase of the design/test project. Furthermore, offline domain 102 trains a machine learning classification model 122 based on telemetry information and power and performance (PnP) information.

In this particular context, the term “offline” (or “design time”) refers herein to operations which are performed by a designer, manufacturer, distributor, wholesaler, system administrator or other such agent other than an end-user—e.g., wherein such operations are prior to, or otherwise independent of, one or more devices being operated, by or otherwise on behalf of, such an end-user. In an embodiment, operations performed with offline domain 102 are to determine multiple workload classes—e.g., to generate respective definitions and/or other suitable information which specifies or otherwise indicates criteria for belonging to any one of the multiple workload classes. Alternatively or in addition, operations performed with offline domain 102 are to train a classification model 122 (e.g., comprising a machine learning model) to be able to variously classify workloads as belonging each to a respective one of the multiple workload classes. Alternatively or in addition, operations performed with offline domain 102 are to provide a description of a classification function which represents the functionality of the trained classification model 122.

Alternatively or in addition, system 100 comprises an online domain 104 which comprises resources to implement an inference engine (in firmware, for example)—based on the trained classification model 122—to facilitate runtime selection of any of various frequency ratios, such as uncore/core frequency ratios, based on runtime telemetry information. In this particular context, the term “online” (alternatively, “runtime” or “in-field”) refers herein to operations which are performed with a device—such as the illustrative IC device 140 shown—on behalf of a person or organization which is an end user of said device. In an embodiment, operations performed with online domain 104 are to receive or otherwise determine information which describes a classification function such as one generated based on the training of classification model 122. Alternatively or in addition, operations performed with online domain 104 are to configure an inference engine circuitry 148 of IC device 140 based on said information—e.g., the configuration to enable workload classification according to the described classification function. Alternatively or in addition, operations performed with online domain 104 are to perform one or more workload classifications with the inference engine circuitry 148—e.g., wherein an allocation of a power budget is subsequently modified based on the one or more workload classifications.

In various embodiments, offline domain 102 executes multiple workloads with one or more devices (“test devices” herein) which are each of a device type for which the classification function is to be generated. For example, a given test device comprises any of various suitable multi-core (or other) processors, such as a central processing unit (CPU), a graphics processing unit (GPU), or the like. In an embodiment, a test device—such as a system-on-chip (SoC) or other integrated circuit (IC) die—comprises a processor, an uncore of which includes a respective one or more circuit resources. Such one or more uncore resources are to operate at a frequency (referred to herein as an “uncore frequency”) that is subject to being variously modified at different times—e.g., by power control logic of the processor.

Furthermore, a processor core of such a processor includes a respective one or more circuit resources which are similarly to operate at a frequency (referred to herein as an “core frequency”) that is also subject to being variously modified at different times. For example, an uncore (or core) frequency includes or is otherwise based on a frequency of a clock signal which is provided to one or more uncore (or core) resources—e.g., wherein the processor core receives or generates said clock signal.

In various embodiments, a processor of a test device supports power control functionality whereby an uncore frequency and a core frequency can be variously modified independent of each other. The term “frequency ratio” is used herein to refer to a ratio of a frequency of one or more resources of a processor to a frequency of one or more other resources of the same processor. For example, the term “uncore/core frequency ratio” refers herein to a ratio of an uncore frequency to a core frequency. By contrast, the term “frequency ratio value” is used herein to refer to a particular value (e.g., an actual value, estimated value, predicted value or recommended value) of a given frequency ratio at a particular time—e.g., as contrasted with a different value of the same given frequency ratio at some other time.

In an embodiment, workloads are executed with one or more test devices of offline domain 102 (e.g., including the illustrative test device 110 shown receiving and executing a workload 114), wherein information which is generated based on such execution—e.g., including power and performance data 118, as well as additional telemetry information 116—is used to train classification model 122. In one such embodiment, test device 110 is variously operated at different uncore/core frequency ratio values during an execution of one or more workloads—e.g., wherein configuration information 112 variously (re)configures a during execution of workload 114. In a different embodiment, offline domain 102 is alternatively another online domain or, for example, a different (sub)domain of online domain 104—e.g., wherein some or all of the one or more test devices, represented as test device 110, are operating in-field each on behalf of a respective end user.

In this particular context, “workload” refers herein to some or all of a software process which is to be executed with a particular core—e.g., wherein said core is to execute an instruction sequence of the software process. For example, a workload comprises one or more operations (e.g., including one or more microoperations) which are performed with the given core, each either in preparation for, or as part of, an execution of a respective one or more instructions of the instruction sequence. In some embodiments, a workload is an independent software process—e.g., to be executed on a single core of test device 110—or, alternatively, is a sub-process of a larger software process that is to be executed with multiple cores of test device 110.

In an embodiment, power and performance data 118 and/or telemetry 116 is determined for a particular period of time (referred to herein as a “workload phase”) during the execution of a corresponding workload 114 with a processor core of test device 110. Some or all such test information is analyzed—e.g., with an analyzer 130 of offline domain 102—to facilitate the generation of multiple workload classes and, for each such workload class, a respective discretized value for a parameter (β) which represents a corresponding frequency ratio value (such as an uncore/core frequency ratio value).

In an embodiment, telemetry 116 specifies or otherwise indicates, for example, a characteristic of a utilization of one or more core resources. By way of illustration and not limitation, telemetry 116 indicates characteristics of accesses to a particular one or more caches of a core—e.g., wherein such telemetry information identifies a number of attempts to access said one or more caches during a workload phase. For example, telemetry 116 identifies a number of cache misses—or, for example, cache hits—at said one or more caches during the workload phase. Alternatively or in addition, telemetry 116 identifies (for example) a ratio of misses to hits at the one or more caches during the workload phase.

In some embodiments, telemetry 116 alternatively or additionally indicates one or more characteristics of accesses to a particular one or more uncore resources—e.g., including an identifier of an available bandwidth of an interconnect fabric. Alternatively or in addition, telemetry 116 indicates one or more characteristics of accesses to a memory which is coupled to a processor of test device 110—e.g., including an identifier of an available bandwidth of a memory bus or other such interconnect with the memory.

During execution of the workloads, characteristics of power consumption and performance of the one or more test devices are determined and analyzed. In one such embodiment, analyzer 130 generates reference information 132 which variously corresponds sets of power and performance characteristics each with a respective workload and/or each with a respective frequency ratio. By way of illustration and not limitation, reference information 132 comprises a data table, a number of rows of which is equal to n_{wl}×n_{fcore}×n_{funcore}, wherein n_{wl} is a number of workloads (or workload phases), n_{fcore} is a number of core frequency sweeps, n_{funcore} is a number of uncore frequency (e.g., fabric frequency) sweeps. The number of columns of such table is, for example, equal to a sum of a total number of one or more performance parameters (e.g., hardware performance counters) and a total number of one or more power consumption parameters.

Subsequently, the reference information 132 is analyzed by analyzer 130 to determine one or more relatively optimal core frequency and uncore frequency combinations, wherein the one or more combinations are used for selecting, calculating or otherwise determining, for each of multiple workload classes, a different respective uncore/core frequency ratio value (denoted herein by the value of a parameter β). In an embodiment, each of various uncore/core frequency ratio values is assigned to serve as a discretized frequency ratio values for a different respective workload class. For example, where an inference engine identifies a given workload, in a run time, as belonging to a particular workload class, the inference engine is to provide an output which specifies or otherwise indicates the discretized frequency ratio value which corresponds to that particular workload class. In an embodiment, trainer unit 120 performs operations to train classification model 122 for the purpose of determining a classification function according to which such an inference engine is to subsequently classify different workloads.

In some embodiments, β values are discretized to different respective workload classes—e.g., comprising a compute bound workload (small β) class, a memory bound workload (large β) class, and/or a combination core-memory bound (medium β) class. In one such embodiment, rows of reference information 132 are each assigned a respective one of the discretized β values. For example, a first row is assigned a first discretized α value based on a determination that any workload (or workload state) which has power characteristics and/or performance characteristics indicated in the first row is to belong to a workload class which corresponds to the first discretized β value.

Based on reference information 132 (some or all of which is communicated with a signal 134) and also on telemetry 116 from test device 110, trainer unit 120 trains a classification model 122 to associate various discretized β values each with a different respective workload class. In various embodiments, multiple stages are employed for training classification model 122. By way of illustration and not limitation, a feature selection process is performed—e.g., using a Lasso regression or any of various other suitable techniques. In one such embodiment, the feature selection process is to determine a representative set of features, which are to be available at a runtime and, for example, are correlated to improved results. In an embodiment, a Lasso regression mechanism employs a L-1 norm penalty to an objective function, so that (for example) a weight corresponding to one or more less important features is zero. In turn, this facilitates the selection of more important features (with a non-zero weight). In some instances, dimensionality reduction mechanisms (such as independent component analysis) cannot help with raw feature selection, which can be significant to understand the meaning of the counters selected for the next stage in classification.

Alternatively or in addition, training classification model 122 comprises applying supervised machine learning techniques to empirically identify a preferred classifier function. By way of illustration and not limitation, some embodiments employ a cubic-SVM algorithm, which is a supervised machine learning technique for classification. A cubic-SVM technique is good at mapping continuous input features to a discrete target output (class) which, in this case, is mapping telemetry data to a β value. In various embodiments, a cubic-SVM is effectively a cubic kernel that is applied to a support vector machine (SVM) to facilitate computations with a hyperplane separation, but in a non-linear feature space.

In some embodiments, during a classifier training phase, a classification model implemented with classification model 122 is effectively a boundary function in a multi-dimensional (e.g., a three or more dimension) space. In some embodiments, a relatively memory bound workload class is separated, in the multi-dimensional space, from a relatively compute bound workload class by a classification function ƒ(⋅). According to said classification function ƒ(⋅), telemetry data for a given workload is to be subsequently identified as corresponding to a respective discretized β value which is associated with a particular one of multiple (e.g., three or more) workload classes.

By way of illustration and not limitation, a classification function ƒ(⋅) in some embodiments enables a three or more workload class separation based on three or more telemetry parameters—e.g., as contrasted with two-class separation using only one or two telemetry parameters. In one such embodiment, the function ƒ(⋅) is defined by equation (1) below.

$${f}_{m} ( x ) = {\sum }_{i = 1}^{n} {a}_{i , m} {x}_{i} + {a}_{0 , m} \qquad ( 1 )$$

In an embodiment, during a training phase, some embodiments determine the parameters a_{i,m} ∀ i, m, wherein n is the dimensionality or number of features (e.g., 3), and wherein m is the number of such functions that are stored (e.g., 3).

Some embodiments store information which describes the resulting classifier—i.e., function ƒₘ(⋅)—in a real platform or simulation environment, and subsequently provides said information to facilitate workload classification at a run time with inference engine circuitry of an IC die. In an illustrative scenario according to one such embodiment, a set of telemetry data (×_{new}) is generated during such a runtime based on an execution of a given workload with a core of said IC die. This set of telemetry data is provided—e.g., via the illustrative signal 124 shown—to the inference engine circuitry 148, which is thus configured to determine any of m values {ƒₘ(x_{new})} each for a respective one of the m workload classes which are available for classification of the given workload. In some embodiments, the inference engine circuitry performs a respective one-versus-one comparison for all the workload classes—e.g., wherein a majority vote (the workload class winning by a greatest amount) in each function is then selected to be the basis for recommending a corresponding β value. In an embodiment, a corresponding recommended β value is provided for consideration as to whether (and is so, how) a power budget allocation is to be dynamically modified during the run time.

With the classification function configured at inference engine circuitry 148, IC device 140 is enabled to classify a given workload during runtime execution thereof, and to change the value of a given uncore/core frequency ratio based on the recommendation of a uncore/core frequency ratio value which corresponds to the identified workload class. In an illustrative scenario according to one embodiment, changing such a uncore/core frequency ratio value comprises inference engine circuitry 148 providing one or more signals 149 which—directly or indirectly—change a frequency of one or more cores 142 of IC device 140, and/or change a frequency of one or more resources of an uncore 144 of IC device 140. In the example embodiment shown, such one or more uncore resources comprise an interconnect fabric 146 which couples some or all of cores 142 to each other and/or to other circuit resources.

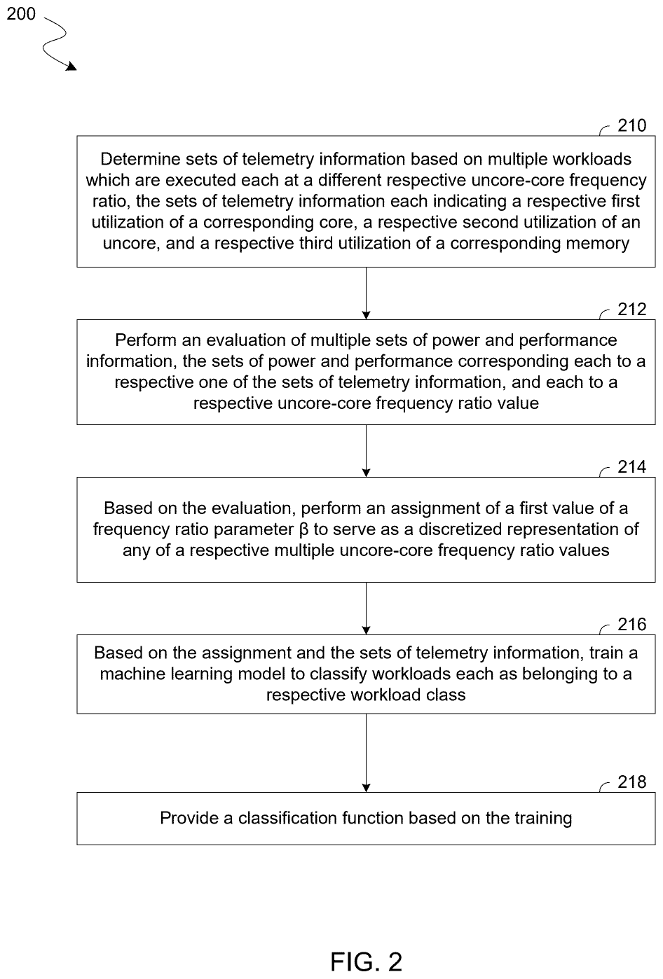

FIG. 2 shows a method 200 for generating a classification function with a machine learning model according to an embodiment. Operations such as those of method 200 are performed with any of various combinations of suitable hardware (e.g., circuitry), firmware and/or executing software which, for example, provide some or all of the functionality of trainer unit 120 and analyzer 130. Method 200 illustrates one example of an embodiment wherein a classification model is trained based on test information which is generated from the execution of multiple workloads. In some embodiments, the test information includes, for a given workload (and, for example, for a given phase of workload execution) a respective set of telemetry information and a respective set of power and performance information.

In one such embodiment, a given set of power and performance information is provided for evaluation to define or otherwise determine multiple workload classes which are each to correspond to a different respective value of an uncore/core frequency ratio. Furthermore, a given set of telemetry information is provided as input to a classification machine learning model, to facilitate training of said model. It is to be noted that a given set of power and performance information, in some embodiments, includes telemetry information other than that of a corresponding set of telemetry information. For example, power and performance information identifies a characteristic of power provisioning and/or power consumption, or identifies a characteristic of data throughput, an instruction execution rate, or any of various other suitable performance metrics.

In some embodiments, the multiple workloads each include a respective execution of the same software instruction sequence. In one such embodiment, a single core successively executes the multiple workloads each at a different respective uncore/core frequency ratio value. Alternatively, multiple cores each execute a different respective one of the multiple workloads at a different respective uncore/core frequency ratio value.

In other embodiments, the multiple workloads include both a first plurality of workloads and a second plurality of workloads, wherein the first plurality of workloads each include a respective execution of a first software instruction sequence, and the second plurality of workloads are each include a respective execution of a second software instruction sequence. In one such embodiment, for a given one such plurality of workloads, a single core successively executes each of the plurality of workloads each at a different respective uncore/core frequency ratio value. Alternatively, for a given one such plurality of workloads, multiple cores each execute a different respective one of the plurality of workloads at a different respective uncore/core frequency ratio value.

As shown in FIG. 2, method 200 comprises (at 210) determining sets of telemetry information based on multiple workloads, some or all of which are executed each at a different respective uncore/core frequency ratio value. In an embodiment, the sets of telemetry information each indicate a respective first utilization of a corresponding core (that is, the core which executes the corresponding workload), a respective second utilization of an uncore of the processor which comprises the corresponding core, and a respective third utilization of a corresponding memory which, for example, is coupled to the processor.

Method 200 further comprises (at 212) performing an evaluation of multiple sets of power and performance information which each correspond to a respective one of the sets of telemetry information, and each to a respective uncore/core frequency ratio value. In one such embodiment, the evaluation at 212 determines, at least in part, whether (and if so, how) subsets of the multiple uncore/core frequency ratio values are to be variously grouped, where each such group is to correspond to a respective workload class. Furthermore, the evaluation at 212 determines, at least in part, a respective uncore/core frequency ratio value which is to correspond to a given one such workload class.

In an illustrative scenario according to one embodiment, some plural sets of power and performance information—i.e., a subset of the multiple sets of power and performance information—are identified at 212 as being relatively similar to each other, relative to others of the multiple sets. Alternatively or in addition, such plural sets are identified at 212 as including or otherwise indicating a respective local maximum of power budget utilization, a respective local maximum of a performance metric, and/or the like. In an embodiment, a respective workload class is defined based on some or all such identified characteristics of the plural sets—e.g., wherein a representative uncore/core frequency ratio value is to be calculated based on the uncore/core frequency ratio values which correspond each to a respective one of the plural sets.

Based on the evaluation performed at 212, method 200 (at 214) performs an assignment of a first value of a frequency ratio parameter β, wherein the first value is to serve as a discretized representation of any of a respective multiple uncore/core frequency ratio values. In some embodiments, the assigning at 214 includes, or is otherwise based on, an identification (e.g., comprising a defining) of multiple workload classes each as including or otherwise corresponding to a different respective telemetry space. In various embodiments, for a given one such workload class, a corresponding range of uncore/core frequency ratio values includes a value which is to serve as the respective discretized representation.

Based on both the assignment performed at 214, and the sets of telemetry information, method 200 (at 216) trains a machine learning model to classify workloads each as belonging to a respective workload class. In an illustrative scenario according to one embodiment, the sets of telemetry information each comprise a respective first telemetry parameter which indicates a utilization of a corresponding core of a processor—e.g., wherein the respective first telemetry parameter indicates a number of misses at one or more caches of the corresponding core. Furthermore, the sets of telemetry information each comprise a respective second telemetry parameter which indicates a utilization of the uncore—e.g., wherein the respective second telemetry parameter indicates an available bandwidth of an interconnect fabric. Further still, the sets of telemetry information each comprise a respective third telemetry parameter which indicates a utilization of a corresponding memory—e.g., wherein the respective third telemetry parameter indicates an available bandwidth of the memory. In one such embodiment, the training at 216 is based on each of the first telemetry parameter, the second telemetry parameter, and the third telemetry parameter.

In various embodiments, the training at 216 is based, for example, on telemetry information which identifies whether a command pipe of the processor is currently in a valid state. In some embodiments, the training at 216 is additionally or alternatively based, for example, on an identifier of a respective number of one or more inter-process communications which are performed with the corresponding core

Method 200 further comprises (at 218) providing a classification function which is based on the training performed at 216. For example, information which identifies the classification function is communicated to configure an inference engine circuit (e.g., that of inference engine circuitry 148) of an IC die or other device which comprises any of various suitable processors.

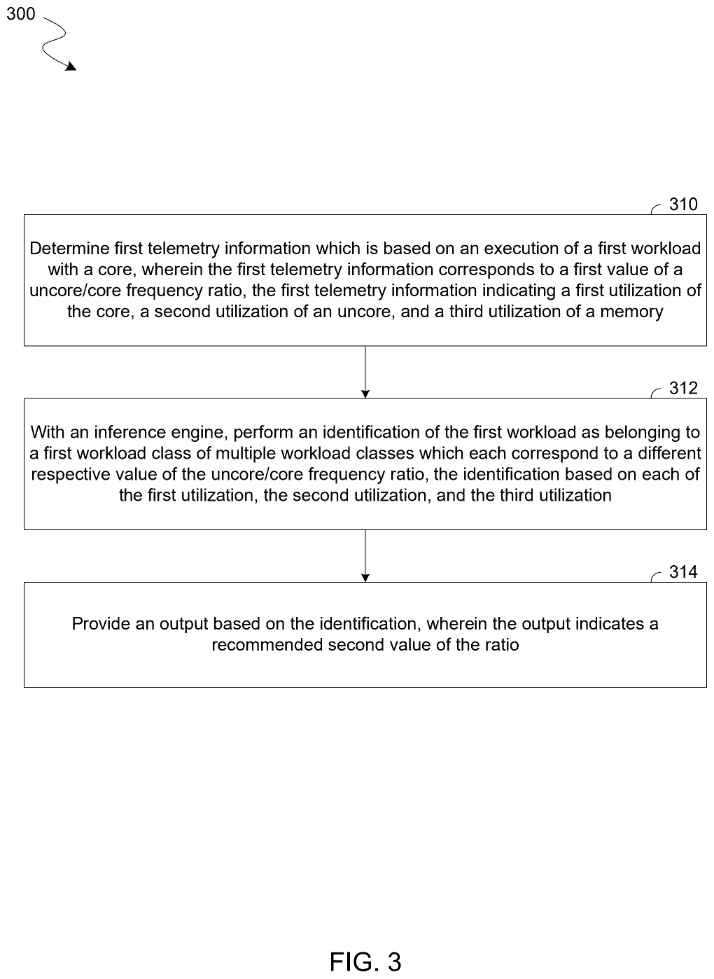

FIG. 3 shows a method 300 for classifying a workload with an inference engine circuit according to an embodiment. Method 300 illustrates one example of an embodiment wherein runtime workload classification is performed to determine a recommend a value for an uncore/core frequency ratio (such as a fabric/core frequency ratio). Operations such as those of method 300 are performed with any of various combinations of suitable hardware (e.g., circuitry), firmware and/or executing software which, for example, provide some or all of the functionality of IC device 140.

As shown in FIG. 3, method 300 comprises (at 310) determining first telemetry information which is based on an execution of a first workload with a core of a processor. The first telemetry information corresponds to a first value of a uncore/core frequency ratio of the processor—e.g., wherein the first telemetry information is generated in a workload phase during which the uncore/core frequency ratio is at the first value.

In an embodiment, the first telemetry information indicates a first utilization of the core, a second utilization of an uncore of the processor, and a third utilization of a memory which is coupled to the processor. By way of illustration and not limitation, the first telemetry information comprises a first telemetry parameter which specifies or otherwise indicates a number of misses at one or more caches of the core, a ratio of cache hits to cache misses at the core, or the like. Alternatively or in addition, the first telemetry information further comprises a second telemetry parameter which specifies or otherwise indicates an available bandwidth of an interconnect fabric. Alternatively or in addition, the first telemetry information further comprises a third telemetry parameter which specifies or otherwise indicates an available bandwidth of the memory. In some embodiments, the telemetry information comprises an identifier of whether (for example) a command pipe of the processor is currently in a valid state. Alternatively or in addition, the telemetry information comprises an identifier of a number of one or more inter-process communications which are performed with the core. However, some embodiments are not limited with respect to particular types of telemetry information which indicate the first utilization, the second utilization, or the third utilization.

With an inference engine circuit—such as inference engine circuitry 148 for example—method 300 further performs (at 312) an identification of the first workload as belonging to a first one of multiple workload classes which each correspond to a different respective value of the uncore/core frequency ratio. For example, in an illustrative scenario according to one embodiment, the multiple workload classes comprise a first “compute bound” workload class which corresponds to a first telemetry space. Furthermore, the multiple workload classes comprise a second “fabric bound” workload class which is associated with a second telemetry space, wherein the first telemetry space (as compared to the second telemetry space) corresponds to a relatively high utilization of one or more first resources of the core, and to a relatively low utilization of one or more second resources of the uncore. Further still, the multiple workload classes comprise a third workload class which is associated with a third telemetry space which, relative to the first telemetry space and the second telemetry space, corresponds to an intermediate utilization of the one or more first resources, and/or to or an intermediate utilization of the one or more second resources.

In various embodiments, the inference engine circuit comprises a microcontroller which executes firmware to implement a machine learning model which classifies workloads with a classification function. In one such embodiment, the machine learning model comprises any of various suitable neural networks.

In an embodiment, the identification is performed at 312 is based on each of the first telemetry parameter, the second telemetry parameter, and the third telemetry parameter. In one such embodiment, the inference engine circuit is configured to implement a classification function which is able to identify any one of multiple (e.g., three or more) possible workload classes, wherein input parameters of the classification function include each of a core telemetry parameter, an uncore telemetry parameter, and a memory system telemetry parameter.

Based on the identifying performed at 312, method 300 (at 314) provides an output which indicates a recommended second value of the ratio. In an embodiment, one of a first frequency or a second frequency (e.g., an uncore frequency or a core frequency) is changed based on the output provided at 314. For example, the uncore comprises an interconnect fabric which operates at the first frequency.

In some embodiments, method 300 further comprises one or more operations (not shown) which are to resolve a (possible) acceptance of the recommended second value of the ratio with one or more power management algorithms. In various embodiments, the uncore/core frequency ratio is changed from the first value to the recommended second value or, alternatively, to some third value which is identified by such resolving (or, for example, by any of various other suitable power management evaluations based on the recommendation of the second value).

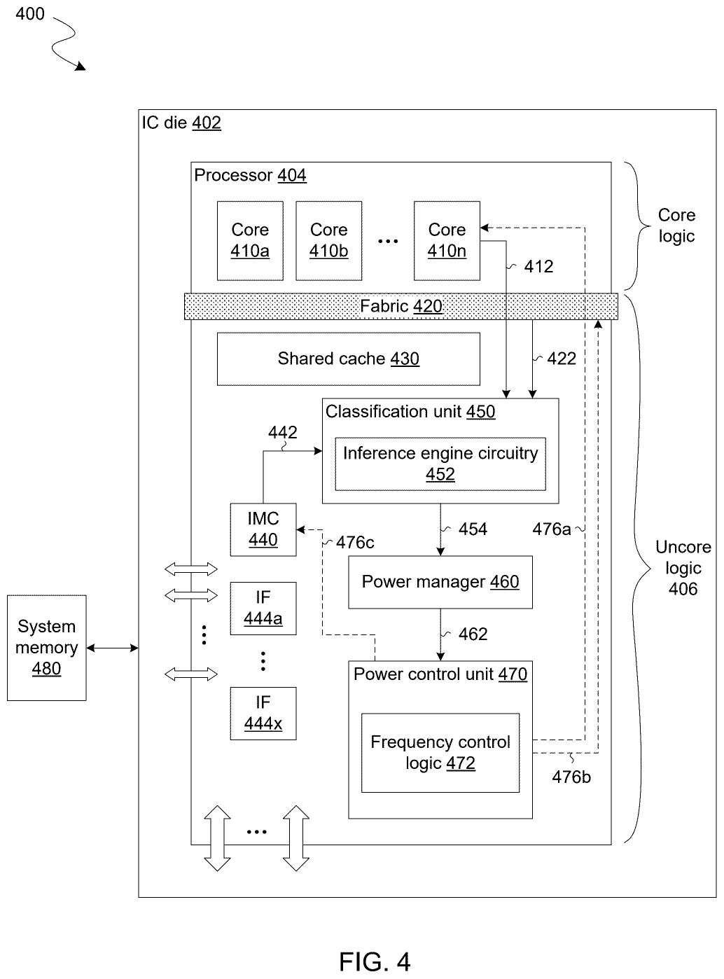

Some embodiments are implemented in processors for various markets including server processors, desktop processors, mobile processors and so forth. FIG. 4 shows a system 400 which enables workload classification with an inference engine according to an embodiment. In some embodiments, system 400 provides functionality such as that of IC device 140—e.g., wherein operations of method 200 and/or operations of method 300 are performed to facilitate functionality of system 400.

As shown in FIG. 4, system 400 comprises an IC die 402 and a system memory 480 which is coupled thereto. IC die 402 comprises a processor 404 which includes core logic and uncore logic 406 that (for example) correspond functionally to cores 142 and uncore 144 (respectively). In an embodiment, processor 404 is a multicore processor including a plurality of cores 410a, 410b, . . . , 410n. In one embodiment, some or all such core is each of a respective independent power domain, where each such core is able to be configured to independently enter and exit any of various active power states—e.g., based on a current state of a corresponding workload executed with that core. In the example embodiment shown, the various cores are coupled via an interconnect fabric 420 to an uncore 406 that includes various components. As shown, the uncore 406 includes a shared cache 430 which (for example) is a last level cache. In addition, the uncore 406 includes an integrated memory controller (IMC) 440, various interfaces (IFs) 444a, . . . , 444x, a power control unit 470, a power manager 460 and a classification unit 450. In various embodiments, inference engine circuitry 452 of classification unit 450 corresponds functionally to inference engine circuitry 148 (for example).

With further reference to FIG. 4, processor 404 communicate with a system memory 480 (such as a dynamic random access memory), e.g., via a memory bus. Alternatively or in addition, interfaces 444a, . . . , 444x enable connection to be made to any of various suitable off-chip components such as one or more peripheral devices, mass storage and/or the like. While shown with this particular implementation in the embodiment of FIG. 4, the scope of some embodiments is not limited in this regard.

In an embodiment, inference engine circuitry 452 provides functionality to variously classify workloads each as belonging to a respective one of multiple (e.g., three or more) possible workload classes. For example, inference engine circuitry 452 has been configured based on information which represents a classification function that, in one example embodiment, has been generated based on training of classification model 122. Furthermore, inference engine circuitry 452 provides functionality to associate the possible workload classes each with a different respective value of a frequency ratio (such as a uncore/core frequency ratio).

Classification unit 450 is coupled to determine one or more sets of telemetry information, wherein each such set corresponds to a respective workload phase and to a respective workload. For example, a given such set of telemetry information corresponds to a workload which is executed by one of cores 410.

In an illustrative scenario according to one embodiment, classification unit 450 receives a set of telemetry information during a corresponding phase of a workload, wherein the set comprises (for example) telemetry 412 from core 410n, telemetry 422 from fabric 420 (which in this example, is in an uncore domain), and telemetry 442 from IMC 440. Based on each of the various core telemetry 412, fabric telemetry 422, and memory system telemetry 442 for the workload phase, inference engine circuitry 452 detects a workload state of the corresponding workload. Based on said state, inference engine circuitry 452 classifies the corresponding workload as being in a particular workload class (at least during the workload phase in question) of the multiple workload classes which each correspond to a different respective frequency ratio value.

Based on said classification, classification unit 450 provides to power manager 460 a signal 454 which specifies or otherwise indicates a corresponding suggested value for a frequency ratio. In this example embodiment, the frequency ratio is a ratio of an operational frequency of fabric 420 to an operational frequency of at least the one of cores which executes the classified workload. Power manager 460 comprises hardware logic and/or firmware logic (for example) to determine, at least in part, whether one or more clock signals and/or other features of operational characteristics are to be changed to facilitate the frequency ratio transitioning to the value suggested by signal 454 (or to some other value which power manager 460 identifies with an evaluation which is based on the suggested value). For example, power manager 460 identifies an extent to which one operational frequency is to be increased (if at all) and/or identifies an extent to which another operational frequency is to be decreased (if at all).

Based on the frequency ratio value which is suggested by signal 454, power manager 460 outputs a signal 462 which specifies or otherwise indicates to power control unit 470 one or more changes which are each to be made to a different respective operational frequency of processor 404. Based on signal 462, the frequency control logic 472 of power control unit 470 is operated to generate one or more control signals each to modify, or to facilitate modification of, a respective operational frequency. In the example embodiment shown, frequency control logic 472 generates some or all of a control signal 476a which facilitates a change to a frequency of core 410n, a control signal 476b which facilitates a change to a frequency of fabric 420, and a control signal 476c which facilitates a change to a frequency of IMC 440 (and/or of system memory 480, for example). The particular control signals 476a-c shown are merely illustrative, and any of various additional or alternative control signals facilitate a change to the value of the uncore/core frequency ratio, in different embodiments.

In other embodiments, functionality such as that of classification unit 450 is provided in any of various use cases such as a datacenter-level controller or a rack-level controller. In one such embodiment, telemetry is sent from all processors in a given rack to a rack controller, which aggregates the telemetry and makes determinations for respective uncore/core frequency ratios for each of the processors.

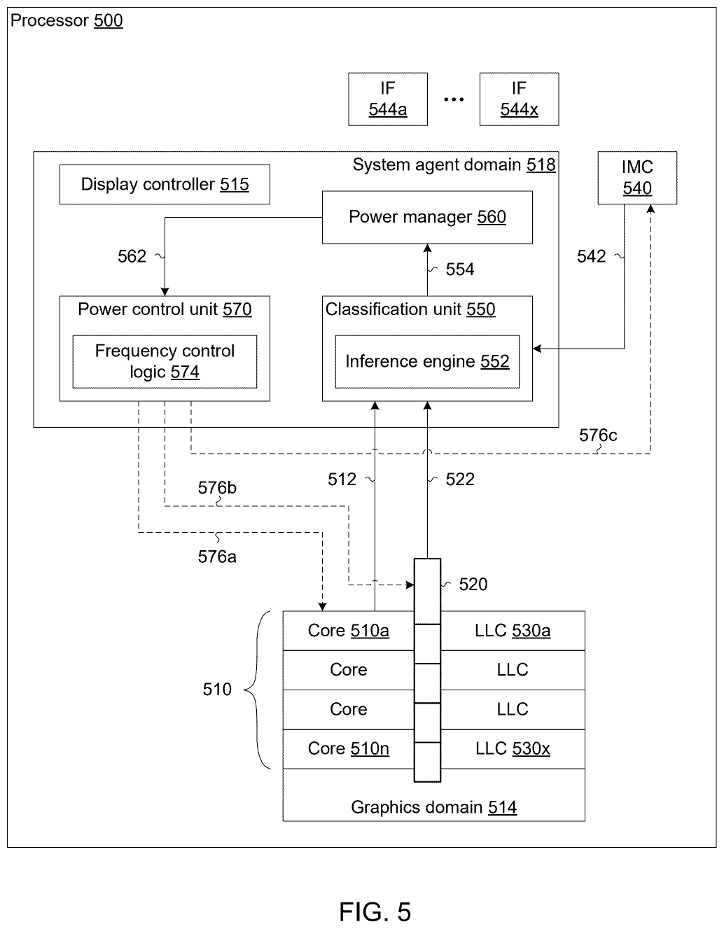

FIG. 5 shows features of a processor 500 which dynamically adapts an power allocation to various domains according to an embodiment. Processor 500 illustrates an embodiment comprising an inference engine which facilitates a change to an uncore/core frequency ratio, wherein said change modifies an allocation of power to a domain which (for example) comprises multiple processor cores. In some embodiments, processor 500 provides functionality such as that of IC device 140 or processor 404—e.g., wherein operations of method 200 or 300 are performed to facilitate some or all such functionality.

As shown in the embodiment of FIG. 5, processor 500 includes multiple domains. Specifically, a core domain 510 includes a plurality of cores 510a, . . . , 510n, wherein a graphics domain 514 include one or more graphics engines, and wherein a system agent domain 518 (e.g., including some or all of an uncore) is further present. In some embodiments, system agent domain 518 execute at an independent frequency than the core domain 510—e.g., wherein system agent domain 518 remains powered on at all times to handle power control events and power management such that domains 510 and 514 can be controlled to dynamically enter into and exit high power and low power states. Each of domains 510 and 514 may operate at different voltage and/or power. It is to be appreciated that, while only three domains are shown, the scope of some embodiments is not limited in this regard and additional domains and/or other domains are present in other embodiments. For example, multiple core domains may be present each including at least one core.

In general, some or all of cores 510 each include a respective one or more low level caches—e.g., in addition to various respective execution units and additional processing elements. In turn, some or all of cores 510 are variously coupled to each other and to a respective shared cache memory, such as some or all of the illustrative last level caches (LLCs) 530a through 530x shown. In various embodiments, a given LLC 530 is shared by multiple cores of domain 510 and/or by a graphics engine of graphics domain 514 (for example). As seen, a ring interconnect 520 couples cores of domain 510 together, and provides interconnection between said cores, graphics domain 514 and one or more circuit resources of system agent domain 518. In one embodiment, ring interconnect 520 is part of an uncore domain or (alternatively) is of its own domain.

As further seen, system agent domain 518 includes a display controller 515 which, for example, provides control of and an interface to an associated display (not shown). Furthermore, system agent domain 518 comprises a power control unit 570 which includes frequency control logic 574, hardware and/or firmware of which (for example) is to enable configure one or more target operating frequencies each for a different respective one of core domain 510, graphics domain 514 and system agent domain 518.

In some embodiments, processor 500 further includes an integrated memory controller (IMC) 540 that can provide for an interface to a system memory (not shown), such as a dynamic random access memory (DRAM). In one such embodiment, multiple interfaces 544a, . . . , 544x are present to enable interconnection between processor 500 and other circuitry. By way of illustration and not limitation, in one embodiment at least one direct media interface (DMI) interface is provided as well as one or more Peripheral Component Interconnect Express (PCI Express™ (PCIe™)) interfaces. Alternatively or in addition, to provide for communications between other agents such as additional processors or other circuitry, one or more interfaces in accordance with an Intel® Quick Path Interconnect (QPI) protocol are provided, for example. Although shown at a high level in the embodiment of processor 500, it is to be appreciated that the scope of some embodiments are not limited in this regard.

In various embodiments, processor 500 further comprises a power manager 560, and a classification unit 550 which, for example, correspond functionally to power manager 460 and classification unit 450 (respectively). Classification unit 550 comprises an inference engine circuitry 552 which, in some embodiments, provides functionality such as that of inference engine circuitry 148 or inference engine circuitry 452. Inference engine circuitry 552 is configured to implement a classification function according to which workloads are to be variously classified as belonging to any of multiple (e.g., three or more) possible workload classes. For example, inference engine circuitry 552 has received configuration information which represents a classification function that has been generated based on machine language training such as that for classification model 122. In one such embodiment, the configuration information further associates each of the multiple possible workload classes with a different respective uncore/core frequency ratio.

Classification unit 550 is coupled to receive telemetry information during an execution of a workload by a core of core domain core domain 510. By way of illustration and not limitation, during a given phase of the workload, classification unit 550 receives a corresponding set of telemetry information which comprises (for example) core telemetry 512 from domain 510, interconnect telemetry 522 from ring interconnect 520 (which in this example, is in an uncore domain), and memory system telemetry 542 from IMC 540.

Based on each of the various core telemetry 512, interconnect telemetry 522, memory system telemetry 542 which is generated for a given phase of the workload, inference engine circuitry 552 detects a workload state of that workload, and—base on said state—classifies the workload as being (at least during the given workload phase) in a particular workload class of the multiple possible workload classes. Based on said classification, classification unit 550 outputs a signal 554 which specifies or otherwise indicates to power manager 560 a suggested value for a frequency ratio (where said value corresponds to that particular workload class).

In this example embodiment, the frequency ratio is a ratio of an operational frequency of ring interconnect 520 (and, for example, of one or more other uncore resources) to an operational frequency of some or all cores of core domain 510. Power manager 560 comprises hardware logic and/or firmware logic (for example) to resolve the frequency ratio value which is suggested by signal 554 with one or more power management algorithms with which power manager 560 further manages the allocation of a power budget for processor 500.

In an embodiment, resolving the suggested frequency ratio value with a given power management algorithm comprises determining whether an acceptance of the suggested frequency ratio value is consistent with (e.g., does not violate) a power management decision which would otherwise be made by the given power management algorithm in the absence of the suggestion by signal 554. Alternatively or in addition, resolving the suggested frequency ratio value with a given power management algorithm comprises weighting the suggestion by signal 554 against each of one or more power management decisions which would otherwise be made, each by a different respective power management algorithm, in the absence of the suggestion by signal 554. In various embodiments, resolving the suggested frequency ratio value with one or more algorithms includes operations adapted from conventional power management techniques for determining a power configuration based on multiple indicated power configurations.

Based on signal 554 (and, for example, a resolving of the suggested frequency ratio with one or more power management algorithms), power manager 560 identifies a next value for the uncore/core frequency ratio. Where the identified next frequency ratio value is different than a current value of the uncore/core frequency ratio, power manager 560 outputs a signal 562 which specifies or otherwise indicates to power control unit 570 one or more changes which are each to be made to a different respective operational frequency of processor 500.

Based on signal 562, the frequency control logic 574 of power control unit 570 is operated to generate one or more control signals each to modify, or to facilitate modification of, a respective operational frequency of a corresponding power domain. By way of illustration and not limitation, frequency control logic 574 generates some or all of a control signal 576a which facilitates a change to a frequency of core domain core domain 510, a control signal 576b which facilitates a change to a frequency of ring interconnect 520, and a control signal 576c which facilitates a change to a frequency of IMC 540. Any of various additional or alternative control signals are communicated to change the uncore/core frequency ratio, in different embodiments.

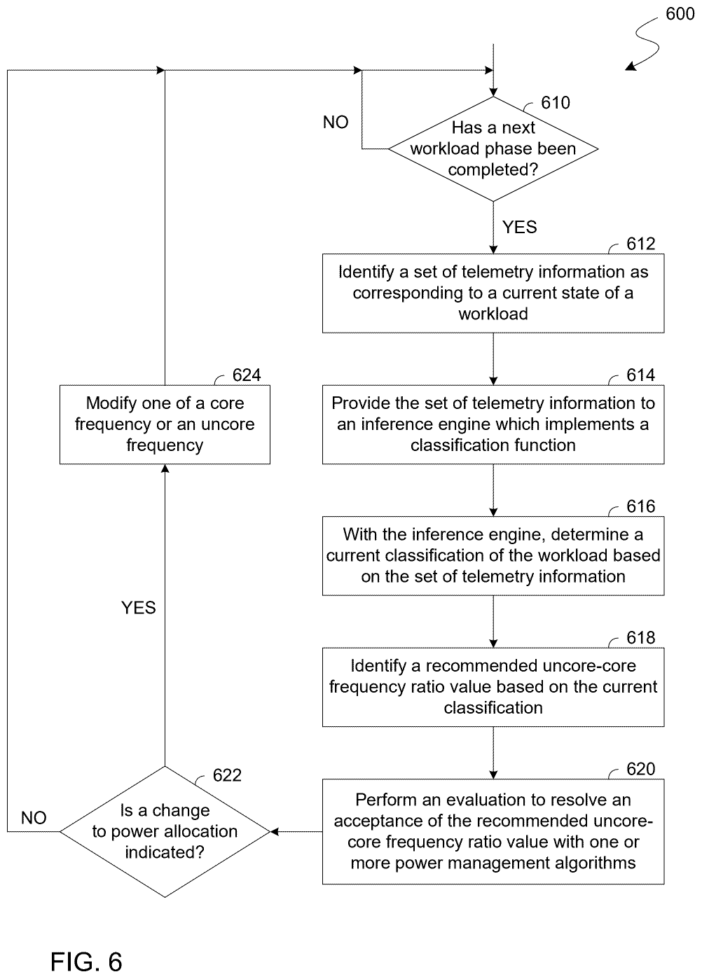

FIG. 6 shows a method 600 for determining dynamic modifications to an allocation of a power budget according to an embodiment. Method 600 illustrates one example of an embodiment wherein workload classifications, each for a different respective workload phase, are successively performed each to facilitate a determination as to whether (and if so, how) a respective value of a corresponding frequency ratio is to be modified. Operations such as those of method 600 are performed with any of various combinations of suitable hardware (e.g., circuitry), firmware and/or executing software which, for example, provide some or all of the functionality of one of IC device 140, IC die 402, or processor 500—e.g., wherein method 600 includes features of method 300 and/or is based on information which is generated by method 200.

As shown in FIG. 6, method 600 comprises performing an evaluation (at 610) to determine whether some next workload phase—i.e., for which classification of a corresponding workload has yet to be performed—has completed. Where it is determined at 610 that any such next workload phase has yet to be completed, method 600 performs a next instance of the evaluating at 610. Where it is instead determined at 610 that such a workload phase been completed, method 600 (at 612) identifies some received set of telemetry information as corresponding to a current state of a workload. In some embodiments, the evaluating at 610 is to monitor changes to a state of only one workload which is executed with one and only one processor core. In other embodiments, the evaluating at '610 is to monitor changes to the respective states of multiple workloads which (for example) are executed each with a different respective one and only one processor core.

Method 600 further comprises (at 614) providing the set of telemetry information, which was most recently identified at 612, to an inference engine—such as inference engine circuitry 552, or one provided with inference engine circuitry 148 or inference engine circuitry 452—which implements a classification function. The classification function is to identify a given workload as corresponding to a particular one of multiple workload classes which each correspond to a different respective value of an uncore/core frequency ratio (such as a fabric/core frequency ratio). In an embodiment, inference engine is configured based on information which is generated with design time machine learning training (such as that for classification model 122).

Based on the telemetry information, method 600 (at 616) determines with the inference engine a current classification of the workload which corresponds to said telemetry information. Based on the current classification determined at 616, method 600 (at 618) identifies a recommended uncore-core frequency ratio value which corresponds to the workload class to which the workload currently belongs.

Method 600 further comprises (at 620) performing an evaluation to resolve an acceptance of the recommended uncore-core frequency ratio value with one or more power management algorithms. In an embodiment, performing the evaluation at 620 comprises identifying whether an acceptance of the suggested frequency ratio value would be consistent with a power management decision which, in the absence of the uncore-core frequency ratio value being suggested, would otherwise be made by some other power management algorithm. Alternatively or in addition, performing the evaluation at 620 comprises weighting the suggestion by signal 554 against each of one or more power management decisions which, in the absence of the uncore-core frequency ratio value being suggested, would otherwise be made each by a different respective power management algorithm.

Method 600 further comprises performing an evaluation (at 622) to determine whether a result of the evaluation performed at 620 indicates that a current allocation of power is to be changed (and, for example, that the change is to include a change to a value of an uncore/core frequency ratio). Where it is determined at 622 that no such change to the current power allocation is indicated, method 600 performs a next instance of the evaluating at 610. Where it is instead determined at 622 that a change to the current power allocation is indicated, method 600 (at 624) generates one or more control signals which, for example, are to modify one of a core frequency or an uncore frequency. After the modifying at 624, method 600 performs a next instance of the evaluating at 610.

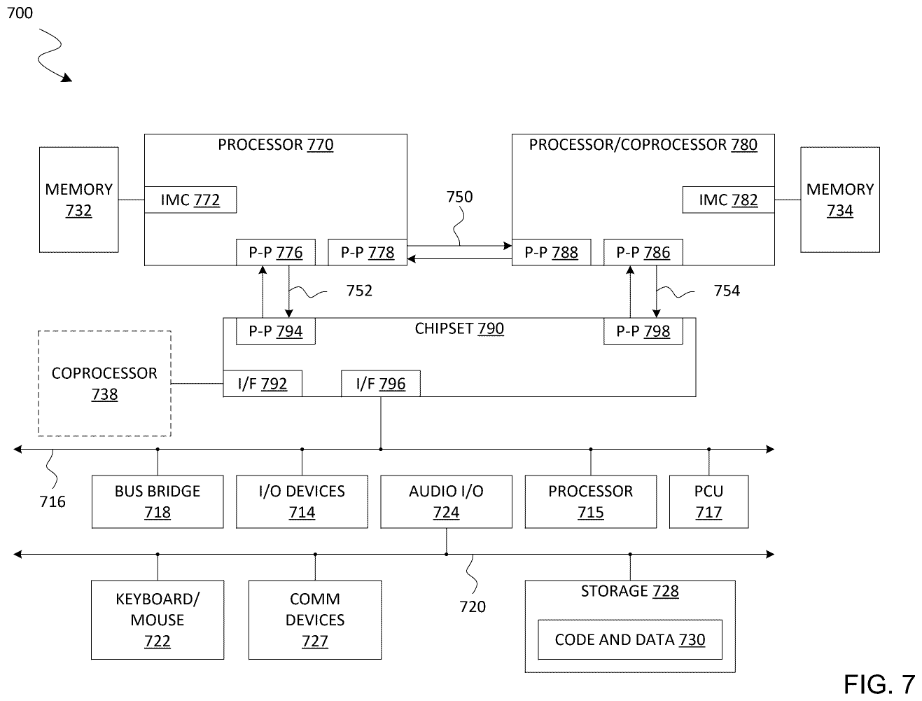

FIG. 7 illustrates an exemplary system. Multiprocessor system 700 is a point-to-point interconnect system and includes a plurality of processors including a first processor 770 and a second processor 780 coupled via a point-to-point interconnect 750. In some examples, the first processor 770 and the second processor 780 are homogeneous. In some examples, first processor 770 and the second processor 780 are heterogenous. Though the exemplary system 700 is shown to have two processors, the system may have three or more processors, or may be a single processor system.

Processors 770 and 780 are shown including integrated memory controller (IMC) circuitry 772 and 782, respectively. Processor 770 also includes as part of its interconnect controller point-to-point (P-P) interfaces 776 and 778; similarly, second processor 780 includes P-P interfaces 786 and 788. Processors 770, 780 may exchange information via the point-to-point (P-P) interconnect 750 using P-P interface circuits 778, 788. IMCs 772 and 782 couple the processors 770, 780 to respective memories, namely a memory 732 and a memory 734, which may be portions of main memory locally attached to the respective processors.

Processors 770, 780 may each exchange information with a chipset 790 via individual P-P interconnects 752, 754 using point to point interface circuits 776, 794, 786, 798. Chipset 790 may optionally exchange information with a coprocessor 738 via an interface 792. In some examples, the coprocessor 738 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 770, 780 or outside of both processors, yet connected with the processors via P-P interconnect, such that either or both processors' local cache information may be stored in the shared cache if a processor is placed into a low power mode.

Chipset 790 may be coupled to a first interconnect 716 via an interface 796. In some examples, first interconnect 716 may be a Peripheral Component Interconnect (PCI) interconnect, or an interconnect such as a PCI Express interconnect or another I/O interconnect. In some examples, one of the interconnects couples to a power control unit (PCU) 717, which may include circuitry, software, and/or firmware to perform power management operations with regard to the processors 770, 780 and/or co-processor 738. PCU 717 provides control information to a voltage regulator (not shown) to cause the voltage regulator to generate the appropriate regulated voltage. PCU 717 also provides control information to control the operating voltage generated. In various examples, PCU 717 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 717 is illustrated as being present as logic separate from the processor 770 and/or processor 780. In other cases, PCU 717 may execute on a given one or more of cores (not shown) of processor 770 or 780. In some cases, PCU 717 may be implemented as a microcontroller (dedicated or general-purpose) or other control logic configured to execute its own dedicated power management code, sometimes referred to as P-code. In yet other examples, power management operations to be performed by PCU 717 may be implemented externally to a processor, such as by way of a separate power management integrated circuit (PMIC) or another component external to the processor. In yet other examples, power management operations to be performed by PCU 717 may be implemented within BIOS or other system software.

Various I/O devices 714 may be coupled to first interconnect 716, along with a bus bridge 718 which couples first interconnect 716 to a second interconnect 720. In some examples, one or more additional processor(s) 715, such as coprocessors, high-throughput many integrated core (MIC) processors, GPGPUs, accelerators (such as graphics accelerators or digital signal processing (DSP) units), field programmable gate arrays (FPGAs), or any other processor, are coupled to first interconnect 716. In some examples, second interconnect 720 may be a low pin count (LPC) interconnect. Various devices may be coupled to second interconnect 720 including, for example, a keyboard and/or mouse 722, communication devices 727 and a storage circuitry 728. Storage circuitry 728 may be one or more non-transitory machine-readable storage media as described below, such as a disk drive or other mass storage device which may include instructions/code and data 730 in some examples. Further, an audio I/O 724 may be coupled to second interconnect 720. Note that other architectures than the point-to-point architecture described above are possible. For example, instead of the point-to-point architecture, a system such as multiprocessor system 700 may implement a multi-drop interconnect or other such architecture.

### Exemplary Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include on the same die as the described CPU (sometimes referred to as the application core(s) or application processor(s)), the above described coprocessor, and additional functionality. Exemplary core architectures are described next, followed by descriptions of exemplary processors and computer architectures.

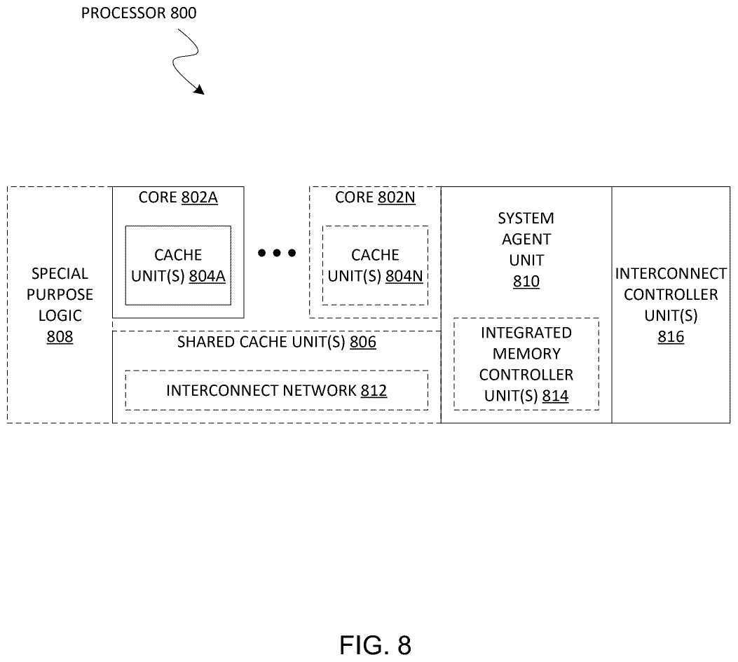

FIG. 8 illustrates a block diagram of an example processor 800 that may have more than one core and an integrated memory controller. The solid lined boxes illustrate a processor 800 with a single core 802A, a system agent unit circuitry 810, a set of one or more interconnect controller unit(s) circuitry 816, while the optional addition of the dashed lined boxes illustrates an alternative processor 800 with multiple cores 802A-N, a set of one or more integrated memory controller unit(s) circuitry 814 in the system agent unit circuitry 810, and special purpose logic 808, as well as a set of one or more interconnect controller units circuitry 816. Note that the processor 800 may be one of the processors 770 or 780, or co-processor 738 or 715 of FIG. 7.

Thus, different implementations of the processor 800 may include: 1) a CPU with the special purpose logic 808 being integrated graphics and/or scientific (throughput) logic (which may include one or more cores, not shown), and the cores 802A-N being one or more general purpose cores (e.g., general purpose in-order cores, general purpose out-of-order cores, or a combination of the two); 2) a coprocessor with the cores 802A-N being a large number of special purpose cores intended primarily for graphics and/or scientific (throughput); and 3) a coprocessor with the cores 802A-N being a large number of general purpose in-order cores. Thus, the processor 800 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 800 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 804A-N within the cores 802A-N, a set of one or more shared cache unit(s) circuitry 806, and external memory (not shown) coupled to the set of integrated memory controller unit(s) circuitry 814. The set of one or more shared cache unit(s) circuitry 806 may include one or more mid-level caches, such as level 2 (L2), level 3 (L3), level 4 (L4), or other levels of cache, such as a last level cache (LLC), and/or combinations thereof. While in some examples ring-based interconnect network circuitry 812 interconnects the special purpose logic 808 (e.g., integrated graphics logic), the set of shared cache unit(s) circuitry 806, and the system agent unit circuitry 810, alternative examples use any number of well-known techniques for interconnecting such units. In some examples, coherency is maintained between one or more of the shared cache unit(s) circuitry 806 and cores 802A-N.

In some examples, one or more of the cores 802A-N are capable of multi-threading. The system agent unit circuitry 810 includes those components coordinating and operating cores 802A-N. The system agent unit circuitry 810 may include, for example, power control unit (PCU) circuitry and/or display unit circuitry (not shown). The PCU may be or may include logic and components needed for regulating the power state of the cores 802A-N and/or the special purpose logic 808 (e.g., integrated graphics logic). The display unit circuitry is for driving one or more externally connected displays.

The cores 802A-N may be homogenous in terms of instruction set architecture (ISA). Alternatively, the cores 802A-N may be heterogeneous in terms of ISA; that is, a subset of the cores 802A-N may be capable of executing an ISA, while other cores may be capable of executing only a subset of that ISA or another ISA.

### Exemplary Core Architectures—In-Order and Out-of-Order Core Block Diagram.

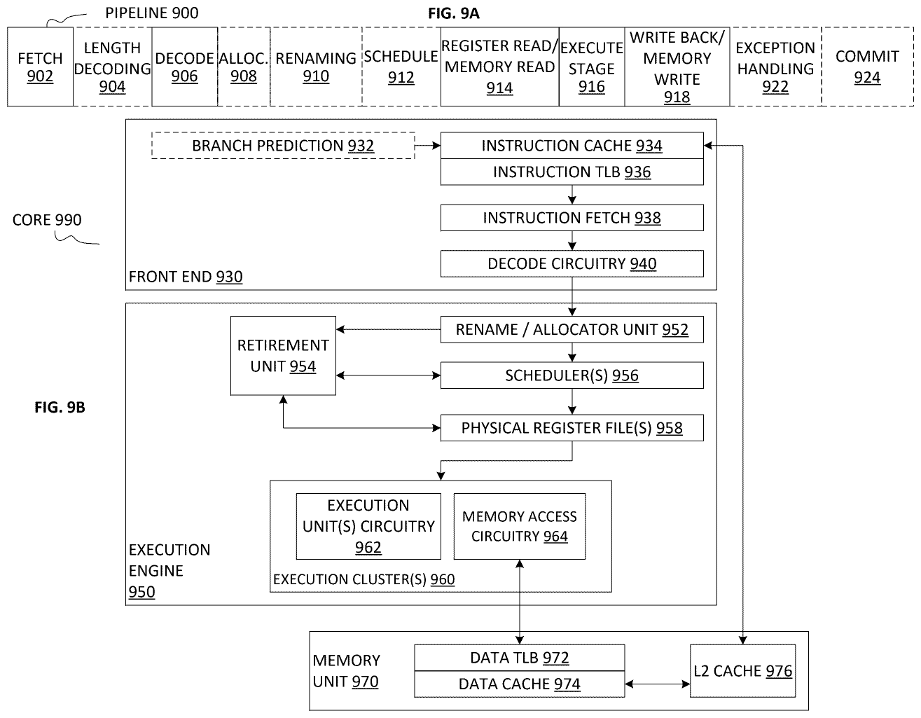

FIG. 9A is a block diagram illustrating both an exemplary in-order pipeline and an exemplary register renaming, out-of-order issue/execution pipeline according to examples. FIG. 9B is a block diagram illustrating both an exemplary example of an in-order architecture core and an exemplary register renaming, out-of-order issue/execution architecture core to be included in a processor according to examples. The solid lined boxes in FIGS. 9A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 9A, a processor pipeline 900 includes a fetch stage 902, an optional length decoding stage 904, a decode stage 906, an optional allocation (Alloc) stage 908, an optional renaming stage 910, a schedule (also known as a dispatch or issue) stage 912, an optional register read/memory read stage 914, an execute stage 916, a write back/memory write stage 918, an optional exception handling stage 922, and an optional commit stage 924. One or more operations can be performed in each of these processor pipeline stages. For example, during the fetch stage 902, one or more instructions are fetched from instruction memory, and during the decode stage 906, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 906 and the register read/memory read stage 914 may be combined into one pipeline stage. In one example, during the execute stage 916, the decoded instructions may be executed, LSU address/data pipelining to an Advanced Microcontroller Bus (AMB) interface may be performed, multiply and add operations may be performed, arithmetic operations with branch results may be performed, etc.

By way of example, the exemplary register renaming, out-of-order issue/execution architecture core of FIG. 9B may implement the pipeline 900 as follows: 1) the instruction fetch circuitry 938 performs the fetch and length decoding stages 902 and 904; 2) the decode circuitry 940 performs the decode stage 906; 3) the rename/allocator unit circuitry 952 performs the allocation stage 908 and renaming stage 910; 4) the scheduler(s) circuitry 956 performs the schedule stage 912; 5) the physical register file(s) circuitry 958 and the memory unit circuitry 970 perform the register read/memory read stage 914; the execution cluster(s) 960 perform the execute stage 916; 6) the memory unit circuitry 970 and the physical register file(s) circuitry 958 perform the write back/memory write stage 918; 7) various circuitry may be involved in the exception handling stage 922; and 8) the retirement unit circuitry 954 and the physical register file(s) circuitry 958 perform the commit stage 924.

FIG. 9B shows a processor core 990 including front-end unit circuitry 930 coupled to an execution engine unit circuitry 950, and both are coupled to a memory unit circuitry 970. The core 990 may be a reduced instruction set architecture computing (RISC) core, a complex instruction set architecture computing (CISC) core, a very long instruction word (VLIW) core, or a hybrid or alternative core type. As yet another option, the core 990 may be a special-purpose core, such as, for example, a network or communication core, compression engine, coprocessor core, general purpose computing graphics processing unit (GPGPU) core, graphics core, or the like.

The front end unit circuitry 930 may include branch prediction circuitry 932 coupled to an instruction cache circuitry 934, which is coupled to an instruction translation lookaside buffer (TLB) 936, which is coupled to instruction fetch circuitry 938, which is coupled to decode circuitry 940. In one example, the instruction cache circuitry 934 is included in the memory unit circuitry 970 rather than the front-end circuitry 930. The decode circuitry 940 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 940 may further include an address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 940 may be implemented using various different mechanisms. Examples of suitable mechanisms include, but are not limited to, look-up tables, hardware implementations, programmable logic arrays (PLAs), microcode read only memories (ROMs), etc. In one example, the core 990 includes a microcode ROM (not shown) or other medium that stores microcode for certain macroinstructions (e.g., in decode circuitry 940 or otherwise within the front end circuitry 930). In one example, the decode circuitry 940 includes a micro-operation (micro-op) or operation cache (not shown) to hold/cache decoded operations, micro-tags, or micro-operations generated during the decode or other stages of the processor pipeline 900. The decode circuitry 940 may be coupled to rename/allocator unit circuitry 952 in the execution engine circuitry 950.

The execution engine circuitry 950 includes the rename/allocator unit circuitry 952 coupled to a retirement unit circuitry 954 and a set of one or more scheduler(s) circuitry 956. The scheduler(s) circuitry 956 represents any number of different schedulers, including reservations stations, central instruction window, etc. In some examples, the scheduler(s) circuitry 956 can include arithmetic logic unit (ALU) scheduler/scheduling circuitry, ALU queues, arithmetic generation unit (AGU) scheduler/scheduling circuitry, AGU queues, etc. The scheduler(s) circuitry 956 is coupled to the physical register file(s) circuitry 958. Each of the physical register file(s) circuitry 958 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 958 includes vector registers unit circuitry, writemask registers unit circuitry, and scalar register unit circuitry. These register units may provide architectural vector registers, vector mask registers, general-purpose registers, etc. The physical register file(s) circuitry 958 is coupled to the retirement unit circuitry 954 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 954 and the physical register file(s) circuitry 958 are coupled to the execution cluster(s) 960. The execution cluster(s) 960 includes a set of one or more execution unit(s) circuitry 962 and a set of one or more memory access circuitry 964. The execution unit(s) circuitry 962 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 956, physical register file(s) circuitry 958, and execution cluster(s) 960 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 964). It should also be understood that where separate pipelines are used, one or more of these pipelines may be out-of-order issue/execution and the rest in-order.

In some examples, the execution engine unit circuitry 950 may perform load store unit (LSU) address/data pipelining to an Advanced Microcontroller Bus (AMB) interface (not shown), and address phase and writeback, data phase load, store, and branches.

The set of memory access circuitry 964 is coupled to the memory unit circuitry 970, which includes data TLB circuitry 972 coupled to a data cache circuitry 974 coupled to a level 2 (L2) cache circuitry 976. In one exemplary example, the memory access circuitry 964 may include a load unit circuitry, a store address unit circuit, and a store data unit circuitry, each of which is coupled to the data TLB circuitry 972 in the memory unit circuitry 970. The instruction cache circuitry 934 is further coupled to the level 2 (L2) cache circuitry 976 in the memory unit circuitry 970. In one example, the instruction cache 934 and the data cache 974 are combined into a single instruction and data cache (not shown) in L2 cache circuitry 976, a level 3 (L3) cache circuitry (not shown), and/or main memory. The L2 cache circuitry 976 is coupled to one or more other levels of cache and eventually to a main memory.

The core 990 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 990 includes logic to support a packed data instruction set architecture extension (e.g., AVX1, AVX2), thereby allowing the operations used by many multimedia applications to be performed using packed data.

In one or more first embodiments, an integrated circuit (IC) die comprises an inference engine circuit to determine first telemetry information which is to be based on an execution of first workload with a core of a processor, wherein the first telemetry information corresponds to a first value of a ratio of a first frequency of an uncore of the processor to a second frequency of the core, and wherein the first telemetry information is to comprise a first telemetry parameter which indicates a utilization of the core, a second telemetry parameter which indicates a utilization of an uncore, and a third telemetry parameter which indicates a utilization of a memory, perform an identification of the first workload as belonging to a first workload class of multiple workload classes which each correspond to a different respective value of the ratio, the identification based on each of the first telemetry parameter, the second telemetry parameter, and the third telemetry parameter, and provide an output based on the identification, wherein the output is to indicate a recommended second value of the ratio, wherein one of first frequency or the second frequency is to be changed based on the output.

In one or more second embodiments, further to the first embodiment, the uncore comprises an interconnect fabric which is to operate at the first frequency.

In one or more third embodiments, further to the first embodiment or the second embodiment, the multiple workload classes are to comprise a first workload class which corresponds to a first telemetry space, a second workload class which corresponds to a second telemetry space, wherein the first telemetry space, as compared to the second telemetry space, corresponds to a relatively high utilization of one or more first resources of the core, and to a relatively low utilization of one or more second resources of the uncore, and a third workload class which corresponds to a third telemetry space which, relative to the first telemetry space and the second telemetry space, corresponds to an intermediate utilization of the one or more first resources, or to or an intermediate utilization of the one or more second resources.

In one or more fourth embodiments, further to any of the first through third embodiments, the IC die further comprises a power manager circuit coupled to receive the output from the inference engine circuit, power manager circuit to resolve an acceptance of the recommended second value of the ratio with one or more power management algorithms.

In one or more fifth embodiments, further to any of the first through fourth embodiments, the first telemetry parameter is to indicate a number of misses at one or more caches of the core.

In one or more sixth embodiments, further to any of the first through fifth embodiments, the second telemetry parameter is to indicate an available bandwidth of an interconnect fabric.

In one or more seventh embodiments, further to any of the first through sixth embodiments, the third telemetry parameter is to indicate an available bandwidth of the memory.

In one or more eighth embodiments, further to any of the first through seventh embodiments, the telemetry information is to comprise an identifier of whether a command pipe of the processor is currently in a valid state.

In one or more ninth embodiments, further to any of the first through eighth embodiments, the telemetry information is to comprise an identifier of a number of one or more inter-process communications which are performed with the core.

In one or more tenth embodiments, further to any of the first through ninth embodiments, the inference engine circuit comprises a microcontroller to execute firmware to provide a machine learning model which is to classify workloads with a classification function.

In one or more eleventh embodiments, further to the tenth embodiment, the machine learning model is to comprise a neural network.

In one or more twelfth embodiments, a method comprises determining first telemetry information which is based on an execution of a first workload with a core of a processor, wherein the first telemetry information corresponds to a first value of a ratio of a first frequency of an uncore of the processor to a second frequency of the core, and wherein the first telemetry information comprises a first telemetry parameter which indicates a utilization of the core, a second telemetry parameter which indicates a utilization of an uncore, and a third telemetry parameter which indicates a utilization of a memory, with an inference engine circuit, performing an identification of the first workload as belonging to a first workload class of multiple workload classes which each correspond to a different respective value of the ratio, the identification based on each of the first telemetry parameter, the second telemetry parameter, and the third telemetry parameter, and providing an output based on the identification, wherein the output indicates a recommended second value of the ratio, wherein one of first frequency or the second frequency is changed based on the output.

In one or more thirteenth embodiments, further to the twelfth embodiment, the uncore comprises an interconnect fabric which operates at the first frequency.

In one or more fourteenth embodiments, further to the twelfth embodiment or the thirteenth embodiment, the multiple workload classes comprise a first workload class which corresponds to a first telemetry space, a second workload class which corresponds to a second telemetry space, wherein the first telemetry space, as compared to the second telemetry space, corresponds to a relatively high utilization of one or more first resources of the core, and to a relatively low utilization of one or more second resources of the uncore, and a third workload class which corresponds to a third telemetry space which, relative to the first telemetry space and the second telemetry space, corresponds to an intermediate utilization of the one or more first resources, or to or an intermediate utilization of the one or more second resources.

In one or more fifteenth embodiments, further to any of the twelfth through fourteenth embodiments, the method further comprises a power manager circuit coupled to receive the output from the inference engine circuit, power manager circuit to resolve an acceptance of the recommended second value of the ratio with one or more power management algorithms.

In one or more sixteenth embodiments, further to any of the twelfth through fifteenth embodiments, the first telemetry parameter indicates a number of misses at one or more caches of the core.

In one or more seventeenth embodiments, further to any of the twelfth through sixteenth embodiments, the second telemetry parameter indicates an available bandwidth of an interconnect fabric.

In one or more eighteenth embodiments, further to any of the twelfth through seventeenth embodiments, the third telemetry parameter indicates an available bandwidth of the memory.

In one or more nineteenth embodiments, further to any of the twelfth through eighteenth embodiments, the telemetry information comprises an identifier of whether a command pipe of the processor is currently in a valid state.

In one or more twentieth embodiments, further to any of the twelfth through nineteenth embodiments, the telemetry information comprises an identifier of a number of one or more inter-process communications which are performed with the core.

In one or more twenty-first embodiments, further to any of the twelfth through twentieth embodiments, the inference engine circuit comprises a microcontroller which executes firmware to provide a machine learning model which classifies workloads with a classification function.

In one or more twenty-second embodiments, further to the twenty-first embodiment, the machine learning model comprises a neural network.

In one or more twenty-third embodiments, one or more non-transitory computer-readable storage media have stored thereon instructions which, when executed by one or more processing units, cause the one or more processing units to perform a method comprising determining first telemetry information which is based on an execution of a first workload with a core of a processor, wherein the first telemetry information corresponds to a first value of a ratio of a first frequency of an uncore of the processor to a second frequency of the core, and wherein the first telemetry information comprises a first telemetry parameter which indicates a utilization of the core, a second telemetry parameter which indicates a utilization of an uncore, and a third telemetry parameter which indicates a utilization of a memory, with an inference engine, performing an identification of the first workload as belonging to a first workload class of multiple workload classes which each correspond to a different respective value of the ratio, the identification based on each of the first telemetry parameter, the second telemetry parameter, and the third telemetry parameter, and providing an output based on the identification, wherein the output indicates a recommended second value of the ratio, wherein one of first frequency or the second frequency is changed based on the output.

In one or more twenty-fourth embodiments, further to the twenty-third embodiment, the uncore comprises an interconnect fabric which is to operate at the first frequency.

In one or more twenty-fifth embodiments, further to the twenty-third embodiment or the twenty-fourth embodiment, the multiple workload classes comprise a first workload class which corresponds to a first telemetry space, a second workload class which corresponds to a second telemetry space, wherein the first telemetry space, as compared to the second telemetry space, corresponds to a relatively high utilization of one or more first resources of the core, and to a relatively low utilization of one or more second resources of the uncore, and a third workload class which corresponds to a third telemetry space which, relative to the first telemetry space and the second telemetry space, corresponds to an intermediate utilization of the one or more first resources, or to or an intermediate utilization of the one or more second resources.

In one or more twenty-sixth embodiments, further to any of the twenty-third through twenty-fifth embodiments, the method further comprises resolving an acceptance of the recommended second value of the ratio with one or more power management algorithms.

In one or more twenty-seventh embodiments, further to any of the twenty-third through twenty-sixth embodiments, the first telemetry parameter indicates a number of misses at one or more caches of the core.

In one or more twenty-eighth embodiments, further to any of the twenty-third through twenty-seventh embodiments, the second telemetry parameter indicates an available bandwidth of an interconnect fabric.

In one or more twenty-ninth embodiments, further to any of the twenty-third through twenty-eighth embodiments, the third telemetry parameter indicates an available bandwidth of the memory.

In one or more thirtieth embodiments, further to any of the twenty-third through twenty-ninth embodiments, the telemetry information comprises an identifier of whether a command pipe of the processor is currently in a valid state.

In one or more thirty-first embodiments, further to any of the twenty-third through thirtieth embodiments, the telemetry information comprises an identifier of a number of one or more inter-process communications which are performed with the core.

In one or more thirty-second embodiments, further to any of the twenty-third through thirty-first embodiments, the inference engine comprises a machine learning model which classifies workloads with a classification function.

In one or more thirty-third embodiments, further to the thirty-second embodiment, the machine learning model is to comprise a neural network.

In one or more thirty-fourth embodiments, a device comprises a trainer unit comprising circuitry to determine sets of telemetry information based on multiple workloads which are executed each at a different respective uncore-core frequency ratio, wherein the sets of telemetry information are each to comprise a respective first telemetry parameter which indicates a utilization of a corresponding core of a processor, a respective second telemetry parameter which indicates a utilization of an uncore of the processor, and a respective third telemetry parameter which indicates a utilization of a corresponding memory, and an analyzer unit comprising circuitry to perform an evaluation of sets of power and performance information which correspond each to a respective one of the sets of telemetry information, and each to a different respective one of multiple uncore-core frequency ratios, wherein, based on the evaluation, the analyzer unit is further to perform an assignment of a first value of parameter β to serve as a discretized representation of any of the multiple uncore-core frequency ratios, wherein the trainer unit is further to train a machine learning model, based on the assignment and the sets of telemetry information, to classify workloads each as belonging to a respective workload class, and to provide a classification function based on the training.

In one or more thirty-fifth embodiments, further to the thirty-fourth embodiment, the classification function is to be provided to an inference engine circuit of an integrated circuit (IC) die.

In one or more thirty-sixth embodiments, further to the thirty-fourth embodiment or the thirty-fifth embodiment, the respective first telemetry parameter is to indicate a number of misses at one or more caches of the corresponding core.

In one or more thirty-seventh embodiments, further to any of the thirty-fourth through thirty-sixth embodiments, the respective second telemetry parameter is to indicate an available bandwidth of an interconnect fabric.

In one or more thirty-eighth embodiments, further to any of the thirty-fourth through thirty-seventh embodiments, the respective third telemetry parameter is to indicate an available bandwidth of the memory.

In one or more thirty-ninth embodiments, further to any of the thirty-fourth through thirty-eighth embodiments, the telemetry information comprises an identifier of whether a command pipe of the processor is currently in a valid state.

In one or more fortieth embodiments, further to any of the thirty-fourth through thirty-ninth embodiments, the sets of telemetry information each comprise an identifier of a respective number of one or more inter-process communications which are performed with the corresponding core.

In one or more forty-first embodiments, a method comprises determining sets of telemetry information based on multiple workloads which are executed each at a different respective uncore-core frequency ratio, the sets of telemetry information each comprising a respective first telemetry parameter which indicates a utilization of a corresponding core of a processor, a respective second telemetry parameter which indicates a utilization of an uncore of the processor, and a respective third telemetry parameter which indicates a utilization of a corresponding memory, performing an evaluation of sets of power and performance information which correspond each to a respective one of the sets of telemetry information, and each to a different respective one of multiple uncore-core frequency ratios, based on the evaluation, performing an assignment of a first value of parameter β to serve as a discretized representation of any of the multiple uncore-core frequency ratios, based on the assignment and the sets of telemetry information, training a machine learning model to classify workloads each as belonging to a respective workload class, and providing a classification function based on the training.

In one or more forty-second embodiments, further to the forty-first embodiment, the classification function is provided to an inference engine circuit of an integrated circuit (IC) die.

In one or more forty-third embodiments, further to the forty-first embodiment or the forty-second embodiment, the respective first telemetry parameter indicates a number of misses at one or more caches of the corresponding core.

In one or more forty-fourth embodiments, further to any of the forty-first through forty-third embodiments, the respective second telemetry parameter indicates an available bandwidth of an interconnect fabric.

In one or more forty-fifth embodiments, further to any of the forty-first through forty-fourth embodiments, the respective third telemetry parameter indicates an available bandwidth of the memory.

In one or more forty-sixth embodiments, further to any of the forty-first through forty-fifth embodiments, the telemetry information comprises an identifier of whether a command pipe of the processor is currently in a valid state.

In one or more forty-seventh embodiments, further to any of the forty-first through forty-sixth embodiments, the sets of telemetry information each comprise an identifier of a respective number of one or more inter-process communications which are performed with the corresponding core.

Techniques and architectures for determining an operational state of an integrated circuit are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. An integrated circuit (IC) die comprising:
an inference engine circuit to:
determine first telemetry information which is to be based on an execution of first workload with a core of a processor, wherein the first telemetry information corresponds to a first value of a ratio of a first frequency of an uncore of the processor to a second frequency of the core, and wherein the first telemetry information is to comprise a first telemetry parameter which indicates a utilization of the core, a second telemetry parameter which indicates a utilization of an uncore, and a third telemetry parameter which indicates a utilization of a memory;
perform an identification of the first workload as belonging to a first workload class of multiple workload classes which each correspond to a different respective value of the ratio, the identification based on each of the first telemetry parameter, the second telemetry parameter, and the third telemetry parameter; and
provide an output based on the identification, wherein the output is to indicate a recommended second value of the ratio, wherein one of first frequency or the second frequency is to be changed based on the output.

2. The IC die of claim 1, wherein the uncore comprises an interconnect fabric which is to operate at the first frequency.

3. The IC die of claim 1, wherein the inference engine circuit comprises a microcontroller to execute firmware to provide a machine learning model which is to classify workloads with a classification function.

4. The IC die of claim 1, wherein the multiple workload classes are to comprise:
a first workload class which corresponds to a first telemetry space;
a second workload class which corresponds to a second telemetry space, wherein the first telemetry space, as compared to the second telemetry space, corresponds to a relatively high utilization of one or more first resources of the core, and to a relatively low utilization of one or more second resources of the uncore; and
a third workload class which corresponds to a third telemetry space which, relative to the first telemetry space and the second telemetry space, corresponds to an intermediate utilization of the one or more first resources, or to or an intermediate utilization of the one or more second resources.

5. The IC die of claim 1, further comprising:
a power manager circuit coupled to receive the output from the inference engine circuit, power manager circuit to resolve an acceptance of the recommended second value of the ratio with one or more power management algorithms.

6. The IC die of claim 1, wherein the first telemetry parameter is to indicate a number of misses at one or more caches of the core.

7. The IC die of claim 1, wherein the second telemetry parameter is to indicate an available bandwidth of an interconnect fabric.

8. One or more non-transitory computer-readable storage media having stored thereon instructions which, when executed by one or more processing units, cause the one or more processing units to perform a method comprising:
determining first telemetry information which is based on an execution of first workload with a core of a processor, wherein the first telemetry information corresponds to a first value of a ratio of a first frequency of an uncore of the processor to a second frequency of the core, and wherein the first telemetry information comprises a first telemetry parameter which indicates a utilization of the core, a second telemetry parameter which indicates a utilization of an uncore, and a third telemetry parameter which indicates a utilization of a memory;
with an inference engine, performing an identification of the first workload as belonging to a first workload class of multiple workload classes which each correspond to a different respective value of the ratio, the identification based on each of the first telemetry parameter, the second telemetry parameter, and the third telemetry parameter; and
providing an output based on the identification, wherein the output indicates a recommended second value of the ratio, wherein one of first frequency or the second frequency is changed based on the output.

9. The one or more non-transitory computer-readable storage media of claim 8, wherein the uncore comprises an interconnect fabric which is to operate at the first frequency.

10. The one or more non-transitory computer-readable storage media of claim 8, wherein the multiple workload classes comprise:
a first workload class which corresponds to a first telemetry space;
a second workload class which corresponds to a second telemetry space, wherein the first telemetry space, as compared to the second telemetry space, corresponds to a relatively high utilization of one or more first resources of the core, and to a relatively low utilization of one or more second resources of the uncore; and
a third workload class which corresponds to a third telemetry space which, relative to the first telemetry space and the second telemetry space, corresponds to an intermediate utilization of the one or more first resources, or to or an intermediate utilization of the one or more second resources.

11. The one or more non-transitory computer-readable storage media of claim 8, wherein the method further comprises:
resolving an acceptance of the recommended second value of the ratio with one or more power management algorithms.

12. The one or more non-transitory computer-readable storage media of claim 8, wherein the first telemetry parameter indicates a number of misses at one or more caches of the core.

13. The one or more non-transitory computer-readable storage media of claim 8, wherein the second telemetry parameter indicates an available bandwidth of an interconnect fabric.

14. A device comprising:
a trainer unit comprising circuitry to determine sets of telemetry information based on multiple workloads which are executed each at a different respective uncore-core frequency ratio, wherein the sets of telemetry information are each to comprise a respective first telemetry parameter which indicates a utilization of a corresponding core of a processor, a respective second telemetry parameter which indicates a utilization of an uncore of the processor, and a respective third telemetry parameter which indicates a utilization of a corresponding memory; and
an analyzer unit comprising circuitry to perform an evaluation of sets of power and performance information which correspond each to a respective one of the sets of telemetry information, and each to a different respective one of multiple uncore-core frequency ratios, wherein, based on the evaluation, the analyzer unit is further to perform an assignment of a first value of parameter β to serve as a discretized representation of any of the multiple uncore-core frequency ratios;
wherein the trainer unit is further to train a machine learning model, based on the assignment and the sets of telemetry information, to classify workloads each as belonging to a respective workload class, and to provide a classification function based on the training.

15. The device of claim 14, wherein the classification function is to be provided to an inference engine circuit of an integrated circuit (IC) die.

16. The device of claim 14, wherein the respective first telemetry parameter is to indicate a number of misses at one or more caches of the corresponding core.

17. The device of claim 14, wherein the respective second telemetry parameter is to indicate an available bandwidth of an interconnect fabric.

18. The device of claim 14, wherein the respective third telemetry parameter is to indicate an available bandwidth of the memory.

19. The device of claim 14, wherein the telemetry information comprises an identifier of whether a command pipe of the processor is currently in a valid state.

20. The device of claim 14, wherein the sets of telemetry information each comprise an identifier of a respective number of one or more inter-process communications which are performed with the corresponding core.
